(19) United States
(12) Patent Application Publication
(10) Pub. No.: US 2008/0170177 A1
(43) Pub. Date: Jul. 17, 2008

(54) Backlight Module and Liquid Crystal Display using the same

(76) Inventor: Yung-Kan Chen, Tainan County (TW)

Correspondence Address: HDSL, 4331 STEVENS BATTLE LANE, FAIRFAX, VA, 22033, US

(21) Appl. No.: 11/955,486

(22) Filed: Dec. 13, 2007

(30) Foreign Application Priority Data
Jan. 16, 2007 (TW) 096101563

(51) Int. Cl. G02F 1/13357; F21V 29/00

(52) U.S. Cl. 349/64; 362/294; 362/260; 362/235; 349/61; 349/70

(57) ABSTRACT

A backlight module includes a composite film, and at least one light source unit adjacent to at least one opening. The composite film has a thermal transferring layer and a reflecting layer, the reflecting layer being disposed at the thermal transferring layer and having the at least one opening exposing part of the thermal transferring layer. The backlight module can be used in a liquid crystal display. The liquid crystal display has the aforementioned backlight module and a liquid crystal panel, the backlight module being disposed under the liquid crystal panel.

### BACKGROUND

The present invention relates to a light source unit module and a display, particular to a backlight module and a liquid crystal display using the same.

A typical liquid crystal display is capable of displaying a clear and sharp image through millions of pixels that make up the complete image. The liquid crystal display has thus been applied to various electronic equipments, such as mobile phones and notebook computers, in which messages or pictures need to be showed. However, liquid crystals in the liquid crystal display do not themselves emit light. Rather, the liquid crystals have to be lit up by a light source unit so as to clearly and sharply display text and images. The light source unit may be ambient light, or a backlight module attached to the liquid crystal display.

FIG. 1 shows a typical edge-type backlight module 100. The backlight module 100 has a light guide plate (LGP) 110, a printed circuit board (PCB) 120, a plurality of light emitting diodes (LEDs) 130 (FIG. 1 just shows one LED), a metal frame 140, a thermal pad 150, a reflector 160, and a plastic frame 170. The metal frame 140 as a bottom frame receives the LGP 110, the PCB 120, the LEDs 130, the thermal pad 150 and the reflector 160 disposed below the LGP 110. The LEDs 130 disposed on the PCB 120 are electrically connected with the PCB 120, which face one side surface of the LGP 110. The PCB 120 and the thermal pad 150 are disposed between the side surface of the LGP 110 and a sidewall of the metal frame 140. The plastic frame 170 is disposed on the metal frame 140, covering peripheral regions of the backlight module 100, which is used for keeping a predetermined space between the backlight module 100 and a liquid crystal panel (not shown), and fixing elements of the backlight module 100.

However, LEDs 130 produce a large of heat in use, and the large of heat will influence usage life and the optical characteristic of LEDs 130 themselves if the heat can not rapidly be dissipated. For solving the problem, metal core printed circuit board (MCPCB) are used as PCB 120 for improving the heat transferring ratio, and a metal frame 140 is provided in the backlight module 100. Nevertheless, the PCB 120 and the metal frame 140 easily cause interspace therebetween, which makes the heat can not be rapidly transferred to the metal frame 140. Thus, the thermal pad 130 having a predetermined thickness (such as 0.25 to 2.0 millimeter) is needed, which is disposed between the PCB 120 and the metal frame 140. The thickness of the thermal pad 130 is important. If the thickness is thinner, the PCB 120 and the metal frame 140 can not realize a good contact and the thermal transferring ratio can not be improved. If the thickness is thicker, a thermal resistance is high and the thermal transferring ratio also can not be improved. In addition, when the thermal transferring ratio is low, size or thickness of the metal frame 140 needs to be added for improving the thermal transferring ratio. Inevitably, the thicker and larger frame 140 increases cost, weight, thickness, which lowers the competitive power. Moreover, the use of thermal pad 130 also needs to add more cost and assembling time of the backlight module 100.

Accordingly, what is needed is a backlight module and a liquid crystal display that can overcome the above-described deficiencies.

### BRIEF SUMMARY

An exemplary backlight module has a composite film, and at least one light source unit. The composite film is composed by a thermal transferring layer and a reflecting layer, and the reflecting layer has at least one opening exposing part of the thermal transferring layer. The at least one light source unit is set adjacent to the opening of the reflective layer.

An exemplary liquid crystal display has a liquid crystal panel and a backlight module providing light beams to the liquid crystal panel. The backlight module has a composite film and at least one light source unit. The composite film is composed by a thermal transferring layer and a reflecting layer, and the reflecting layer has at least one opening exposing part of the thermal transferring layer.

In the backlight module and the liquid crystal display, the at least one light source unit is a cold cathode fluorescent lamp (CCFL), and an electrode portion of the CCFL is adjacent to the at least one opening.

In one embodiment of the backlight module and the liquid crystal display, each light source unit has a printed circuit board (PCB) and a plurality of point light sources electrically connecting with the PCB. The PCB contacts with the thermal transferring layer exposed by the at least one opening. The PCB is one of a composite material PCB, a flexible PCB, a metal core PCB and a metal base PCB. The point light source is a light emitting diode.

In a first alternate embodiment of the backlight module and the liquid crystal display, the reflecting layer is made from polyethylene terephthalate (PET).

In a second alternate embodiment of the backlight module and the liquid crystal display, the thermal transferring layer is made from metal.

In a third alternate embodiment of the backlight module and the liquid crystal display, the thermal transferring layer is made from one of aluminum (Al), copper (Cu), graphite or their combination.

In a fourth alternate embodiment of the backlight module and the liquid crystal display, further comprising a light guide plate and the light guide plate has a light emitting surface, a bottom surface opposite to the light emitting surface, at least one light incident surface connecting with the light emitting surface and the bottom surface. The composite film has an extending portion surrounding an end of the light guide plate corresponding to the light incident surface, and receiving the at least one light source unit.

In a fifth alternate embodiment of the backlight module and the liquid crystal display, the backlight module further has a diffuser, which is provided on the at least one light source unit corresponding to the at least one opening of the reflecting layer.

In use, the composite film has a large size and covers a large part of the backlight module, and the light source unit is disposed adjacently to the exposed thermal transferring layer. Thus, the heat produced by the light source unit in use can be rapidly transferred to the thermal transferring layer, and can be quickly transferred to a comparatively low temperature region by the good thermal transferring characteristic, and the heat concentration phenomena is dismissed. In addition, the backlight module utilizes the large size of the thermal transferring layer to rapidly dismiss thermal to atmosphere. Therefore, the backlight module does not need a weighty metal frame, and can realize a high heat transferring results, which adds the usage life and the optical characteristics of the backlight module. Furthermore, the multiple piece can be a flexible piece. Thus, the backlight module and the liquid crystal display can be made to a flexible backlight module.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a partial cross-sectional view of a conventional edge-type backlight module;

FIG. 2 is a partial cross-sectional view of a backlight module according to a first embodiment of the present invention;

FIG. 3A and FIG. 3B respectively show two partial cross-sectional views at two perpendicular directions of a backlight module according to a second embodiment of the present invention;

FIG. 4A and FIG. 4B respectively show two partial cross-sectional views of two backlight modules according to a third and a fourth embodiments of the present invention;

FIG. 4C shows a top view of a backlight module according to a fifth embodiment of the present invention, which only shows a light guide plate and a plurality of light source units; and

FIG. 5 is a schematic view of a liquid crystal display according to the present invention.

### DETAILED DESCRIPTION

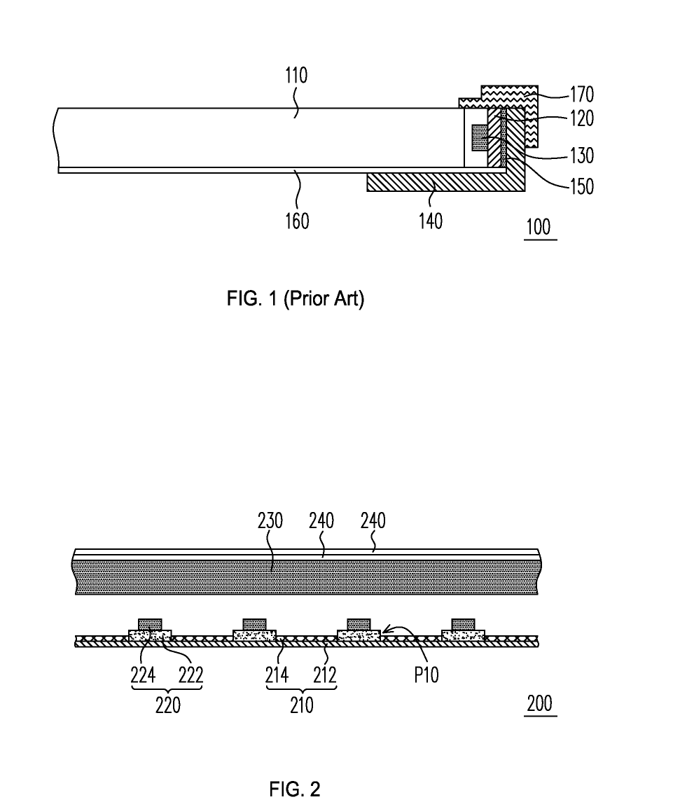

FIG. 2 is a partial cross-sectional view of a backlight module according to a first embodiment of the present invention. The backlight module 200 has a composite film 210 and at least one light source unit 220. The composite film 210 has a thermal transferring layer 212 and a reflecting layer 214. The reflecting layer 214 is disposed on the thermal transferring layer 212. The reflecting layer 214 has at least one opening P10, which exposes a part of thermal transferring layer 212. The light source unit 220 is disposed adjacently to the opening P10, correspondingly. In this embodiment, number of the light source unit 220 and the opening P10 is multiple, and the plurality of light source units 220 and the openings P10 correspond to each other.

In the backlight module 200, the composite film 210 has a large size and covers a large part of the backlight module 200, and the light source unit 220 is disposed adjacently to the exposed thermal transferring layer 212. Thus, the heat produced by the light source unit 220 in use can be rapidly transferred to the thermal transferring layer 212, and can be quickly transferred to a comparatively low temperature region by the good thermal transferring characteristic, and the heat accumulation phenomena is dismissed. In addition, the backlight module 200 utilizes the large size of the thermal transferring layer 212 to rapidly dismiss heat to atmosphere. Therefore, the backlight module 200 does not need a weighty metal frame, and can realize a high heat transferring results, which adds the usage life and the optical characteristics of the backlight module 200. Moreover, the backlight module 200 has an expansively ability. Following a rapid change of all kinds of products, the thermal transferring layer 212 does not need change the size when the number of the light source units 220 adds. Furthermore, the composite film 210 can be a flexible film. Thus, the backlight module 200 can be made to a flexible backlight module.

The material of the reflecting layer 214 can be PET or other materials having a high reflectivity. The thermal transferring layer 212 can be made from a thermal conductive material, like metal material or others having a high thermal transferring ratio, such as aluminum (Al), copper (Cu), graphite or their combination.

The composite film 210 can be made by following methods. In one method, first, providing a PET piece and forming a plurality of openings P10 at the PET piece functioned as the reflecting layer 214; secondly, providing an aluminum foil as the thermal transferring layer 212 and adhering the reflecting layer 214 on the thermal transferring layer 212. In an alternate method, firstly, providing the reflecting layer 214 having a plurality of holes P10; and then sputtering an aluminum material on the reflecting layer 214; finally, adhering an aluminum foil at the openings P10. In another alternate method, firstly, providing an aluminum foil as the thermal transferring layer 212; and then forming the reflecting layer 214 on the thermal transferring layer 212.

The light source unit 220 has a printed circuit board (PCB) 222 and a plurality of point light sources 224, the point light sources 224 being disposed on the PCB 222 and electrically connecting with the PCB 222. The PCB 222 is formed at the thermal transferring layer 212 exposed by the openings P10 and contacts with the thermal transferring layer 212. Because the thermal transferring layer 212 is thinner and soft, the PCB 222 and the thermal transferring layer 212 can attain a good contact effect. No additional thermal pad is needed.

The PCB 222 can be a composite material PCB, such as a PCB having a middle-dielectric layer made from a FR-4 composite material, or be a flexible PCB. If the PCB 222 is a flexible PCB, which can attain a better thermal dissipation efficiency. In addition, the PCB 222 can further be a metal core PCB or a metal base PCB. Moreover, the point light source 224 can be a light emitting diode or others.

The backlight module 200 further has a diffuser 230, which is disposed on the light source unit 224, i.e. the light source unit 224 being disposed between the diffuser 230 and the composite film 210. The diffuser 230 can scatter the light beams from the light source unit 224 for even emitting light beams. In addition, the backlight module 200 can further has a brightness enhancement film, another diffuser, a protective film or other optical films 240 for enhancing the optical characteristics.

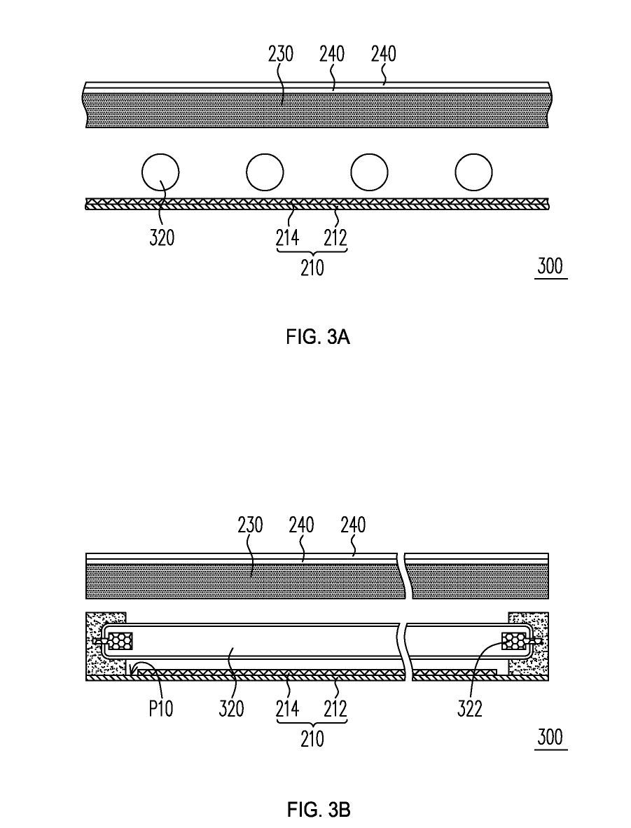

FIG. 3A and 3B show two partial cross-sectional views at two perpendicular directions of a backlight module according to a second embodiment of the present invention. The backlight module 300 has a similar structure to the backlight module 200 except that a light source unit 320 is a cold cathode fluorescent lamp (CCFL), which does not directly contact with a thermal transferring layer 312. The backlight module 300 has a reflecting layer 214 having an opening P10. The opening P10 is under an electrode portion 322 of the light source unit 320, corresponding to an exposed portion of a thermal transferring layer 212. Thus, heat energy produced by the light source unit 320 can be rapidly transferred to a center portion of the thermal transferring layer 312 by the exposed portion thereof. Because the center portion of the thermal transferring layer 312 has a low temperature, which can effectively dissipate heat of the electrode portion 322 of the light source unit 320. Thus, the backlight module 300 also has good heat dissipation efficiency, long usage life, and good optical characteristics.

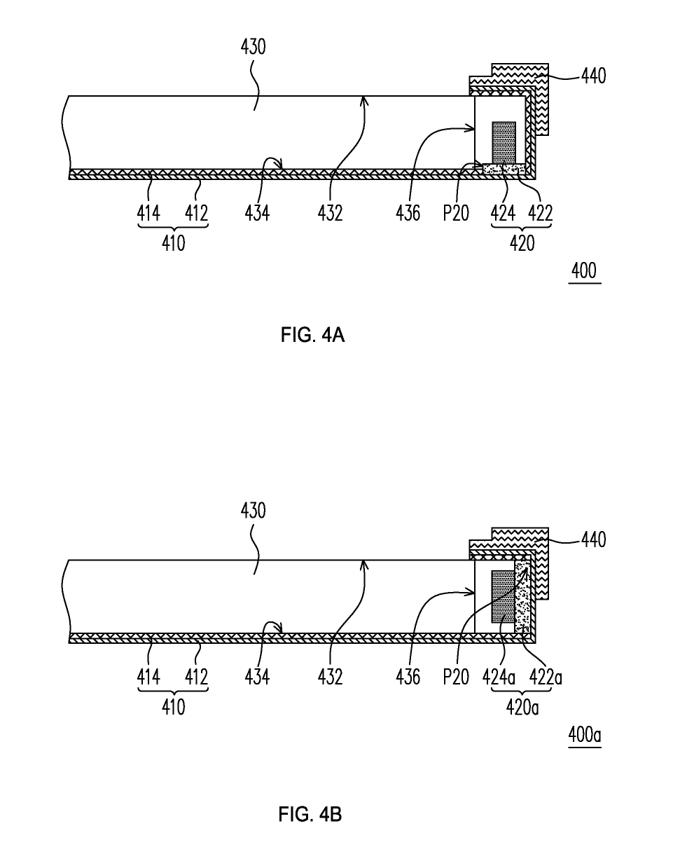

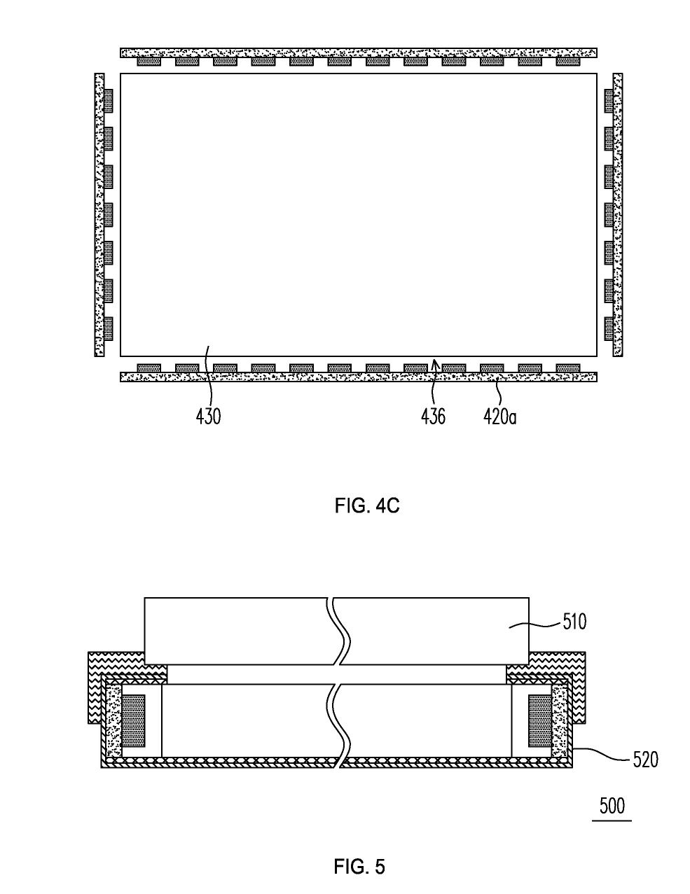

FIG. 4A and FIG. 4B show two partial cross-sectional views of two backlight modules according to a third and a fourth embodiments of the present invention. Referring to FIG. 4A, the backlight module 400 has a composite film 410, at least one light source unit 420 and a light guide plate 430. The composite film 410, the light source unit 420 are respectively similar to the composite film 210, the light source unit 220 of FIG. 2. The light guide plate 430 has a light emitting surface 432, a bottom surface 434 opposite to the light emitting surface 432, at least one light incident surface 436 connecting with the light emitting surface 432 and the bottom surface 434. The bottom surface 434 of light guide plate 430 faces a reflecting layer 414 of the composite film 410. The composite film 410 has an extending portion surrounding an end of the light guide plate 430 corresponding to the light incident surface 436, and receiving the light source unit 420. The light source unit 420 is disposed at an exposed portion of a thermal transferring layer 412 of the composite film 410 exposed by an opening of the reflecting layer 414, and facing the light incident surface 436. A PCB 422 of the light source unit 420 directly contact with the exposed portion of the thermal transferring layer 412. Thus, the backlight module 400 also has good heat dissipation efficiency, long usage life, and good optical characteristics.

In addition, the backlight module 400 further has a frame 440 used for receiving and fixing a liquid crystal panel (not shown) and the backlight module 400 and keeping a predetermined distance between the liquid crystal panel and the backlight module 400.

The light source unit 420 further has at least one point light source 424, which is a side-emitting LED, the PCB 422 being under the point light source 424. The point light source 424 has an emitting surface facing the light incident surface 436 of the light guide plate 430. In an alternate embodiment, as shown in FIG. 4B, a backlight module 400a has a similar structure to that of the backlight module 400 except that a light source unit 420a has at least one point light source 424a being a top-emitting LED, which has an emitting surface facing the light incident surface 436 of the light guide plate 430. In addition, a PCB 422a is disposed between the point light source 424a and the thermal transferring layer 412, facing the light incident surface 436.

FIG. 4C shows a top view of a backlight module according to a fifth embodiment of the present invention, which only show a light guide plate 430 and light source units. The backlight module 400a has a plurality of light incident surfaces 436, for example four incident surfaces. The plurality of light source units respectively faces the plurality of light incident surfaces 436. Each light source unit has a plurality of point light sources 420a, which emit light beams into the light guide plate 430 through the light incident surfaces 436.

FIG. 5 is a schematic view of a liquid crystal display according to the present invention. The liquid crystal display 500 has a liquid crystal panel 510 and a backlight module 520 disposed under the liquid crystal panel 5 10. The backlight module 520 has a same structure to that of the backlight module 400a.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A backlight module comprising:
a composite film, which comprises a thermal transferring layer and a reflecting layer, the reflecting layer has at least one opening to expose part of the thermal transferring layer; and at least one light source unit adjacent to the at least one opening.

2. The backlight module as claimed in claim 1, wherein the at least one light source unit is a cold cathode fluorescent lamp (CCFL).

3. The backlight module as claimed in claim 2, wherein an electrode portion of the CCFL is adjacent to the at least one opening.

4. The backlight module as claimed in claim 1, wherein each light source unit has a printed circuit board (PCB) and a plurality of point light sources electrically connecting with the PCB.

5. The backlight module as claimed in claim 4, wherein the PCB contacts with the thermal transferring layer exposed by the at least one opening.

6. The backlight module as claimed in claim 4, wherein the point light source is a light emitting diode.

7. The backlight module as claimed in claim 4, wherein the thermal transferring layer is made from a thermal conductive material.

8. The backlight module as claimed in claim 1, wherein the light guide plate has a light emitting surface, a bottom surface opposite to the light emitting surface, at least one light incident surface connecting with the light emitting surface and the bottom surface.

9. The backlight module as claimed in claim 1, wherein the composite film has an extending portion surrounding an end of the light guide plate corresponding to the light incident surface, and receiving the at least one light source unit.

10. A liquid crystal display comprising:
a liquid crystal panel; and
a backlight module providing light beams to the liquid crystal panel, which comprises a composite film comprising a thermal transferring layer and a reflecting layer, the reflecting layer has at least one opening to expose part of the thermal transferring layer; and
at least one light source unit adjacent to the at least one opening.

11. The liquid crystal display as claimed in claim 10, wherein the at least one light source unit is a cold cathode fluorescent lamp (CCFL).

12. The liquid crystal display as claimed in claim 10, wherein an electrode portion of the CCFL is adjacent to the at least one opening.

13. The liquid crystal display as claimed in claim 10, wherein each light source unit has a printed circuit board (PCB) and a plurality of point light sources electrically connecting with the PCB.

14. The liquid crystal display as claimed in claim 13, wherein the PCB contacts with the thermal transferring layer exposed by the at least one opening.

15. The liquid crystal display as claimed in claim 13, wherein the point light source is a light emitting diode.

16. The liquid crystal display as claimed in claim 10, wherein the thermal transferring layer is made from a thermal conductive material.

17. The liquid crystal display as claimed in claim 10, wherein the light guide plate has a light emitting surface, a bottom surface opposite to the light emitting surface, at least one light incident surface connecting with the light emitting surface and the bottom surface, the composite film having an extending portion surrounding an end of the light guide plate corresponding to the light incident surface, and receiving the at least one light source unit.

18. The liquid crystal display as claimed in claim 10, wherein the backlight module further has a diffuser, which is provided on the at least one light source unit corresponding to the at least one opening.
